(19) United States
(12) Patent Application Publication
(10) Pub. No.: US 2013/0311274 A1
(43) Pub. Date: Nov. 21, 2013

(54) METHOD AND SYSTEM FOR EDITING A WEB PAGE

(71) Applicants: Chandan ASHOK, Bangalore (IN); Chethan PRAKASH, Bangalore (IN)

(72) Inventors: Chandan ASHOK, Bangalore (IN); Chethan PRAKASH, Bangalore (IN)

(73) Assignee: YAHOO! INC., Sunnyvale, CA (US)

(21) Appl. No.: 13/472,486

(22) Filed: May 16, 2012

(51) Int. Cl. G06F 17/00; G06Q 30/02

(52) U.S. Cl. 705/14.49; 715/234

(57) ABSTRACT

A method and system for editing a web page. The method includes identifying various events, determining one or more edits, performed on a web page, corresponding to each of the events, storing the one or more edits, performed on the web page, in real time, merging the one or more edits performed on the web page with content present on the web page to form an edited web page and displaying the edited web page to the user. The system includes an electronic device, a communication interface and a memory. The system also includes a processor to identify various events, determine one or more edits performed on a web page, store the edits, merge the edits performed on the web page with content present on the web page and display edited web page.

### TECHNICAL FIELD

Embodiments of the disclosure relate to the field of editing web pages.

### BACKGROUND

Editing a web page is becoming increasingly useful since a user can flexibly make changes to the web page. The changes made to the web page are generally personalized to the user. The changes made to the web page are used for one or more purposes based on needs of the user. In one example, the user can edit text included in the web page such that edited text suits an appropriate need of the user and further take a print of the web page that includes the edited text. Further, editing also enables the user to make a note of important points while reading contents included in the web page.

Conventional web editing technique enables the user to edit the web page using an editing icon. The user is required to click on the editing icon to edit necessary sections of the web page as desired. The web editing technique also provides a toolbar for altering fonts, size and color of the edit that is made on the web page. Further, the web editing technique enables the user to insert images and tables to the web page. However, there is no provision to save the edit that is made on the web and hence the edit is lost once the user logs-out of the web page or when the user reloads the web page. Consequently the user is required to download the necessary sections of the web page and save the sections separately on a local disk for editing the sections as desired. Further the web editing technique limits the user to edit only text content.

Another conventional technique enables the user to write notes on a computer having a web browser. The notes written by the user can be saved and hence the user can use the notes for future reference. However, the method is restrained from linking the notes to the web page. Further, the current technique limits the user to write the notes in a text format only.

In the light of the foregoing discussion there is a need for an efficient method and a system for editing the web page such that edits made on the web page can be viewed by the user at a specific time in future.

### SUMMARY

The above-mentioned needs are met by a method, a computer program product and a system for editing a web page.

An example of a method of editing a web page includes identifying a plurality of events performed, by a user, on the web page. The method also includes determining one or more edits, performed on the web page, corresponding to each of the plurality of events. The method further includes storing the one or more edits, performed on the web page, in real time. Further, the method includes merging the one or more edits performed on the web page with content present on the web page to form an edited web page. The merging being performed in response to the user logging into the web page at a specific time in future. Furthermore, the method includes displaying the edited web page to the user.

An example of a computer program product stored on a non-transitory computer-readable medium that when executed by a processor, performs a method of editing a web page. The computer program product includes identifying a plurality of events performed, by a user, on the web page. The computer program product also includes determining one or more edits, performed on the web page, corresponding to each of the plurality of events. The computer program product further includes storing the one or more edits, performed on the web page, in real time. Further, the computer program product includes merging the one or more edits performed on the web page with content present on the web page to form an edited web page. The merging being performed in response to the user logging into the web page at a specific time in future. Furthermore, the method includes displaying the edited web page to the user.

An example of a system for editing a web page includes an electronic device. The system also includes a communication interface in electronic communication with the electronic device. The system further includes a memory that stores instructions. Further the system includes a processor responsive to the instructions to identify a plurality of events performed, by a user, on the web page, determine one or more edits, performed on a web page, corresponding to each of the plurality of events, store the one or more edits, performed on the web page, in real time, merge the one or more edits performed on the web page with content present on the web page to form an edited web page, the merging being performed in response to the user logging into the web page at a specific time in future and display the edited web page to the user.

### BRIEF DESCRIPTION OF THE FIGURES

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, in accordance with which various embodiments can be implemented;

FIG. 2 is a block diagram of a web editable server, in accordance with one embodiment; and

FIG. 3 is a flowchart illustrating a method of editing a web page, in accordance with one embodiment.

### DETAILED DESCRIPTION OF THE EMBODIMENTS

The above-mentioned needs are met by a method, computer program product and system for editing a web page by a user. The following detailed description is intended to provide example implementations to one of ordinary skill in the art, and is not intended to limit the invention to the explicit disclosure, as one or ordinary skill in the art will understand that variations can be substituted that are within the scope of the invention as described.

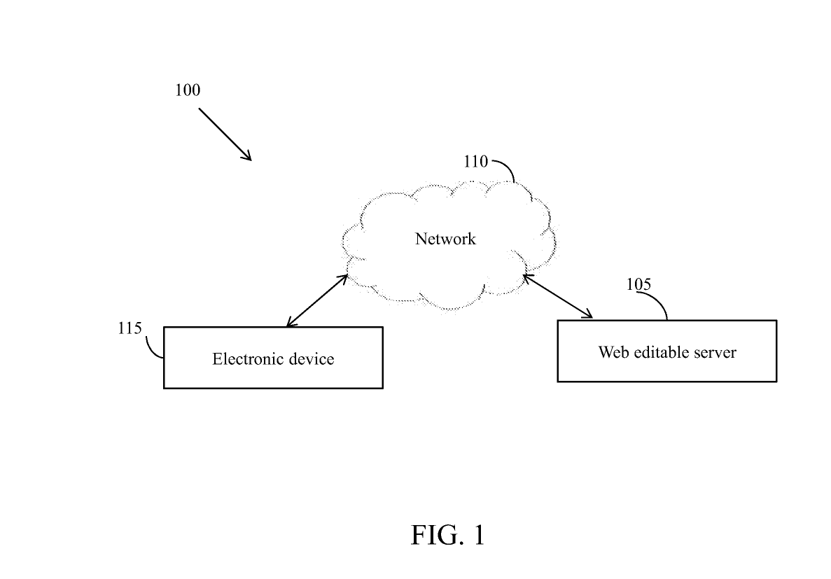

FIG. 1 is a block diagram of an environment 100, in accordance with which various embodiments can be implemented.

The environment 100 includes a web editable server 105 and an electronic device 115. The electronic device 115 can communicate with the web editable server 105 through a network 110. Examples of the electronic device 115 include, but are not limited to, a computer, a mobile phone, a laptop, a palmtop, a hand held device and a personal digital assistant (PDA).

The web editable server 105 is in electronic communication with the electronic device 115 through the network 110. The web editable server 105 can be located remotely with respect to the electronic device 115. Examples of the network 110 include, but are not limited to, a Local Area Network (LAN), a Wireless Local Area Network (WLAN), a Wide Area Network (WAN), internet, and a Small Area Network (SAN).

In some embodiments, an electronic device 115 can perform functions of the web editable server 105.

A user of the electronic device 115 accesses a web page through the network 110. The web page includes different types of content. Examples of the content include, but are not limited to, text, images, videos and advertisements. The user can perform an edit on the web page as desired. Further, the edit performed on the web page is stored such that the user can view the edit when the user accesses the web page once again at a specific time in future. The user can also view the edit when the user reloads the web page at any instant of time. The user can install a plug-in on a web browser of the electronic device 115. The plug-in installed on the web browser enables the user to edit the web page and further save the edit performed on the web page in the web editable server 105. The edit performed on the web page can be made private or public. If the edit performed on the web page is made private, then the edit is displayed to the user in response to the user logging into the web page in future. If the edit performed on the web page is made public, then the edit is displayed to each user accessing the web page. Further, the edit performed on the web page can also be displayed to other users included in a social network, for example Yahoo groups, Facebook and Google groups, of the user.

In one example, the user can wish to highlight specific lines of the text included in the web page. Upon installing the plug-in, the user can select the specific lines of the text using an input device, for example a mouse, and further, the user can highlight the specific lines of the text selected. Highlighting the specific lines of the text is referred to as an edit performed by the user. The edit performed by the user is stored in the web editable server 105 such that the user is enabled to view the specific lines of the text that are highlighted in response to the user accessing the web page at a specific time in future. The user can also view the specific lines of the text that are highlighted when the user reloads the web page at any instant of time. Similarly, the user can underline specific lines of the text present on the web page as desired. Further, the specific lines of the text that is underlined is stored on the web editable server 105 and is viewed by the user when the user accesses the web page at a specific time in future.

In another example, the user can insert a post-it at a required section of the web page. The post-it, in one example, includes information that can be used for future reference, by the user, in one or more data formats. Examples of the data formats include, but are not limited to, text format, image format, video format and audio format. The post-it inserted by the user at the required section of the web page can be referred to the edit performed, by the user, on the web page. The post-it that is inserted is saved on the web editable server 105 such that the post-it can be viewed by the user when the user accesses the web page once again at a specific time in future.

Further, the user can insert one or more images or videos at different sections of the web page. The images and the videos inserted at the different sections are stored on the web editable server 105 such that the images and the videos are present at such sections when the web page is accessed once again, by the user, at a specific time in future.

In yet another example, an advertiser can insert a message that includes an advertisement for a product or a service. The message, in one example, can be in the form of a post-it. The post-it is inserted at desired sections of the web page. The advertisement included in the message is relevant to the content present at the desired sections of the web page. Hence, chances of the user clicking at the advertisement while reading the content is increased. As a result, inserting the post-it including the advertisement enables advertising.

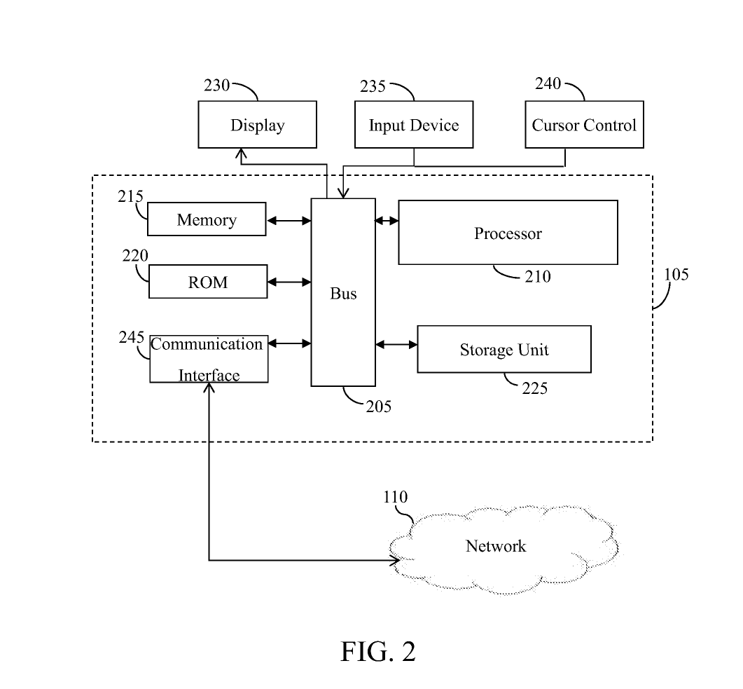

FIG. 2 is a block diagram of a web editable server, for example the web editable server 105, in accordance with one embodiment.

The web editable server 105 includes a bus 205 or other communication mechanism for communicating information, and a processor 210 coupled with the bus 205 for processing information. The web editable server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The web editable server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example information associated with various events performed by a user.

The web editable server 105 can be coupled via the bus 205 to a display 230, for example a cathode ray tube (CRT), for displaying an edited web page to the user. The input device 235, including alphanumeric and other keys, is coupled to the bus 205 for communicating information and command selections to the processor 210. Another type of user input device is the cursor control 240, for example a mouse, a trackball, or cursor direction keys for communicating direction information and command selections to the processor 210 and for controlling cursor movement on the display 230.

Various embodiments are related to the use of the web editable server 105 for implementing the techniques described herein. In some embodiments, the techniques are performed by the web editable server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the web editable server 105, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the web editable server 105 can read. For example, the instructions can initially be carried on a magnetic disk of a remote computer. The remote computer can load the instructions into its dynamic memory and send the instructions over a telephone line using a modem. A modem local to the web editable server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The web editable server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. In any such implementation, the communication interface 245 sends and receives electrical, electromagnetic or optical signals that carry digital data streams representing various types of information.

The processor 210 included in the web editable server 105 is operable to identify the various events performed by the user. The events represent the multiple user interactions of the user with an electronic device of the user. The processor 210 is also operable to determine one or more edits, performed on a web page, corresponding to each of the events. The processor 210 is configured to store data associated with each of the events in a data format. The data format includes the data that can be stored in a database. In one example, the database stores the data in a grid format. Similarly, multiple data formats that include data associated with the events can be stored in the database. Further, the processor 210 is operable to store the edit, performed on the web page, in real time. The processor 210 is further configured to merge the one or more edits performed on the web page with content present on the web page. The processor 210, upon merging, generates an edited web page. The edited web page includes the one or more edits performed, by the user, to the content present on the web page. The processor 210 generates the edited web page in response to the user logging into the web page at a specific time in future. Furthermore, the processor 210 is configured to display the edited web page to the user. The processor 210 is further configured to display the edited web page to one or more users. The one or more users can be present in a social network of the user

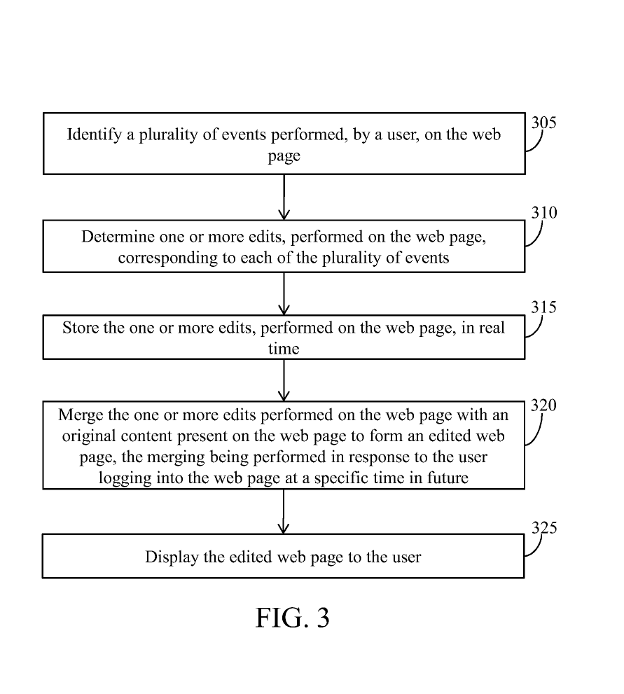

A method for implementing editing of the web page is explained in detail in conjunction with FIG. 3.

FIG. 3 is a flowchart illustrating a method of editing a web page, in accordance with one embodiment.

At step 305, various events performed by the user are identified. Examples of the events include, but are not limited to, movement of an input device, for example a mouse, on a web page, clicking on one or more sections of the web page and selecting the sections of the web page using the input device. The events represent various user interactions performed, by the user, on an electronic device of the user. Each event is associated with a data format. The data format includes data corresponding to the event. The data corresponding to the event is stored in the data format to track an edit, corresponding to the event, on the web page.

At step 310, one or more edits, corresponding to the event, is determined. Examples of the edits include, but are not limited to, inserting a post-it at a required section of the web page, highlighting content present on the required section of the web page, underlining the contents present on the required section of the web page and inserting an image or a video at the required section of the web page. Examples of the content include, but are not limited to, text content, image content and video content. The edits, corresponding to the event, is determined by capturing the event and further analyzing the event performed by the user. Similarly, multiple edits performed by the user that corresponds to various events are determined.

In some embodiments, a plug-in is installed on a web browser that enables the user to edit the web page. The plug-in captures the events performed by the user thereby determining the edits corresponding to the events captured. In one example, the user can perform a right click action using the mouse to enable various edits on the web page.

In some embodiments, a message can be inserted, by an advertiser, at a desired section of the web page. In one example, the message can be in the form of a post-it. The post-it includes an advertisement for a product or a service that is relevant to the content included in the desired section of the web page. The user when reading the content, included in the desired section of the web page, encounters the advertisement that can interest the user. Hence, the method enables to target the user for displaying relevant advertisements to the user.

At step 315, the one or more edits, performed by the user, are stored in real time. The edits are stored on a web editable server, for example, the web editable server 105. The plug-in enables storage of the edits on the web editable server. In one example, each edit is associated with a data format. The data format includes data associated with the edit. The data associated with the edit can be stored in a database. In one example, the database can store the data in a grid format. The edit is stored such that the web page along with the edit can be viewed, by the user, at a specific time in future.

At step 320, the one or more edits performed on the web page is merged with content present on the web page to form an edited web page. Merging is performed in response to the user logging into the web page at a specific time in future. The content present on the web page is obtained from a web server present in a network, for example, the network 110. The edited web page includes the content of the web page in addition to the edit performed by the user. One or more algorithms can be used for merging the edit performed on the web page with the content present on the web page. The merging enables the user to retrieve the edits performed on the web page precisely once the user reloads the web page. Hence, the edits performed earlier is saved and is prevented from being lost.

At step 325, the edited web page is displayed to the user. The user can use the edited web page for reference at a specific time in future. In some embodiments, the edited web page is displayed to one or more users. The one or more users can be present in a social network of the user. Further, in some embodiments, the edited web page can be displayed to each user logging into the web page. The plug-in installed on the web browser enables the user to alter settings such that the edited web page can be public or private. If the edited web page is made public, then the edited web page is displayed to each user logging into the web page. If the edited web page is made private, then the edited web page is displayed to specific users, for example, the users present in the social network of the user.

In one example, the user wishes to read a web page that includes news articles, for example Yahoo! News. The web page can include large number of news articles. As the user is not interested to read each of the news articles present in the web page, the user can select the news articles included in the web page that interest the user. Further, the plug-in installed on the web browser of the user enables the user to insert a post-it on selected news articles such that the user is instantly directed to the selected news articles when the user logs into the web page at a specific time in future. In one example, the user can perform a right click to insert the post-it on the selected news articles.

In another example, the user can insert various comments on a social networking site. Examples of the social networking site include, but are not limited to, Yahoo! Group, Facebook, Google group and Orkut. The plug-in installed on the web browser of the user enables the user to view various comments instantly. The comments presented by friends of the user can also be viewed instantly. The comments presented by the friends of the user can include information for a specific product or a service. Hence, the comments presented by the friends can be used as feedback by the user.

In yet another example, the user wishes to read the web page including sports news. Hence, an advertiser attaches the post-it to the web page that includes an advertisement to advertise sports shoes. The post-it can also include a link that enables the user to purchase the sports shoes. The advertiser can also attach various images and videos for advertising the sports shoes. Hence, interest of the user can be captured to present the advertisement that is relevant to the interest of the user. Therefore, users unwilling to view irrelevant advertisements can be presented with only relevant advertisements. Similarly, various products relevant to sports can be advertised by attaching the post-it.

Further, the plug-in installed in the web browser tracks user interactions in the form of web cookies. The user interactions tracked are used for determining the interest of the user. Further, deals and coupons that are available for products or services corresponding to the interest of the user are presented to the user.

The method specified in the present disclosure enables a user to edit web pages as desired by the user. The method enables the user to insert a post-it, highlight contents and underline contents, included at a desired section of the web page that is similar to attaching a post-it or highlighting contents on a personal book, thereby making the web user friendly. Further, the edits performed on the web page is saved such that the edits can be used for future reference when the user logs into the web page or reloads the web page. The method also enables the user to attach images and videos at the desired section of the web page. Further, the method enables advertisers to add advertisements that are relevant to the content included in the web page, thereby targeting users for generating increased traffic.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of editing a web page, the method comprising:
identifying a plurality of events performed, by a user, on the web page;
determining one or more edits, performed on the web page, corresponding to each of the plurality of events;
storing the one or more edits, performed on the web page, in real time;
merging the one or more edits performed on the web page with content present on the web page to form an edited web page, the merging being performed in response to the user logging into the web page at a specific time in future; and
displaying the edited web page to the user.

2. The method as claimed in claim 1 and further comprising:
displaying the edited web page to one or more users wherein the one or more users are present in a social network of the user.

3. The method as claimed in claim 1 and further comprising:
inserting a message, by an advertiser, at a desired section of the web page wherein the message comprises an advertisement, for at least one of a product and a service, that is relevant to the content included in the desired section of the web page.

4. The method as claimed in claim 1, wherein the plurality of events is captured by installing a plug-in on a web browser of the user.

5. The method as claimed in claim 1, wherein each of the plurality of events is associated with a data format.

6. The method as claimed in claim 5, wherein the data format corresponding to each of the plurality of events comprises data that is stored on a database.

7. A computer program product stored on a non-transitory computer-readable medium that when executed by a processor, performs a method of editing a web page, the method comprising:
identifying a plurality of events performed, by a user, on the web page;
determining one or more edits, performed on the web page, corresponding to each of the plurality of events;
storing the one or more edits, performed on the web page, in real time;
merging the one or more edits performed on the web page with content present on the web page to form an edited web page, the merging being performed in response to the user logging into the web page at a specific time in future; and
displaying the edited web page to the user.

8. The computer program product as claimed in claim 7 and further comprising:
displaying the edited web page to one or more users wherein the one or more users are present in a social network of the user.

9. The computer program product as claimed in claim 7 and further comprising:
inserting a message, by an advertiser, at a desired section of the web page wherein the message comprises an advertisement, for at least one of a product and a service, that is relevant to the content included in the desired section of the web page.

10. The computer program product as claimed in claim 7, wherein the plurality of events is captured by installing a plug-in on a web browser of the user.

11. The computer program product as claimed in claim 7, wherein each of the plurality of events is associated with a data format.

12. The computer program product as claimed in claim 11, wherein the data format corresponding to each of the plurality of events comprises data that is stored on a database.

13. A system for editing a web page, the system comprising:
an electronic device;
a communication interface in electronic communication with the electronic device;
a memory that stores instructions; and
a processor responsive to the instructions to
identify a plurality of events performed, by a user, on the web page;
determine one or more edits, performed on a web page, corresponding to each of the plurality of events;
store the one or more edits, performed on the web page, in real time;
merge the one or more edits performed on the web page with content present on the web page to form an edited web page, the merging being performed in response to the user logging into the web page at a specific time in future; and
display the edited web page to the user.

14. The system as claimed in claim 13, wherein the processor is further configured to display the edited web page to one or more users wherein the one or more users are present in a social network of the user.

15. The system as claimed in claim 13, wherein each of the plurality of events is associated with a data format.

16. The system as claimed in claim 13, wherein the processor is configured to store data associated with the data format on a database.
